(19) United States
(12) Patent Application Publication
(10) Pub. No.: US 2017/0237831 A1
(43) Pub. Date: Aug. 17, 2017

(54) COMPRESSING/DECOMPRESSING FREQUENCY DOMAIN SIGNALS

(71) Applicant: NOKIA SOLUTIONS AND NETWORKS OY, Espoo (FI)

(72) Inventors: Roy YANG, Buffalo Grove, IL (US); Phillip RASKY, Buffalo Grove, IL (US); Timothy JEANES, Arlington Heights, IL (US); Christopher SCHMIDT, Pinole, CA (US)

(21) Appl. No.: 15/044,822

(22) Filed: Feb. 16, 2016

(51) Int. Cl. H04L 29/06; H04L 12/811

(52) U.S. Cl. CPC H04L 69/04; H04L 47/38

(57) ABSTRACT

Various communication systems may benefit from improved bandwidth compression techniques. For example, certain communication systems may benefit from a radio fronthaul traffic compression on a frequency domain data. A method can include identifying a composite waveform corresponding to a real component and an imaginary component of a frequency domain data at a first device. The method may also include causing a transmission of a value that represents the composite waveform to a second device from the first device.

### BACKGROUND

Field

Various communication systems may benefit from improved bandwidth compression techniques. For example, certain communication systems may benefit from a radio fronthaul traffic compression on a frequency domain data.

Description of the Related Art

In order to deal with the exponential nature of data network traffic, it can be helpful to increase the capacity of the communication network. One approach in dealing with the growing data demands may be to utilize a cloud Radio Access Network (C-RAN). In C-RAN, the functionality of a base station may be physically separated into separate network entity, for example, a baseband unit (BBU) and a remote radio unit (RRU). The BBU, which is responsible for signal processing, can be put in a single, centralized location. The RRUs, on the other hand, are responsible for receiving the processed signal from the BBU, and propagating the signal. The RRUs may be placed in different locations, depending on the demands of the network.

Traditionally, the BBUs and RRUs have been connected through fiber cables. Common Public Radio Interface (CPRI) and Open Base station Architecture Initiative (OBSAI) have both been developed to provide a procedure for the communications between the BBUs and the RRUs. Some operators have been using the CPRI interface to aggregate radio carriers via fibers to support connections between BBUs and RRUs over a large geographical area.

To further increase the capacity of a communication system, a compression scheme may be used. Traditional compression schemes, such as U-law compression or linear truncation, however, have been lossy for downlink signals, leading to inefficiencies in the communication system, for example.

### SUMMARY

According to certain embodiments, an apparatus may include at least one memory including computer program code, and at least one processor. The at least one memory and the computer program code may be configured, with the at least one processor, to cause the apparatus at least to identify a composite waveform corresponding to a real component and an imaginary component of a frequency domain data at a first device. The at least one memory and the computer program code may also be configured, with the at least one processor, to cause the apparatus to cause a transmission of a value that represents the composite waveform to a second device from the first device.

A method, in certain embodiments, may include identifying a composite waveform corresponding to a real component and an imaginary component of a frequency domain data at a first device. The method may also include causing a transmission of a value that represents the composite waveform to a second device from the first device.

An apparatus, in certain embodiments, may include means for identifying a composite waveform corresponding to a real component and an imaginary component of a frequency domain data at a first device. The apparatus may also include means for causing a transmission of a value that represents the composite waveform to a second device from the first device.

According to certain embodiments, a non-transitory computer-readable medium encoding instructions that, when executed in hardware, perform a process. The process may include identifying a composite waveform corresponding to a real component and an imaginary component of a frequency domain data at a first device. The process may also include causing a transmission of a value that represents the composite waveform to a second device from the first device.

According to certain other embodiments, a computer program product may encode instructions for performing a process. The process may include identifying a composite waveform corresponding to a real component and an imaginary component of a frequency domain data at a first device. The process may also include causing a transmission of a value that represents the composite waveform to a second device from the first device.

According to certain embodiments, an apparatus may include at least one memory including computer program code, and at least one processor. The at least one memory and the computer program code may be configured, with the at least one processor, to cause the apparatus at least to receive, at a second device, a value from a first device. The value represents a composite waveform corresponding to a real component and an imaginary component of a frequency domain data. The at least one memory and the computer program code may also be configured, with the at least one processor, to cause the apparatus at least to recover, at the second device, the frequency domain data via the value.

A method, in certain embodiments, may include receiving, at a second device, a value from a first device. The value represents a composite waveform corresponding to a real component and an imaginary component of a frequency domain data. The method may also include recovering, at the second device, the frequency domain data via the value.

An apparatus, in certain embodiments, may include means for receiving, at a second device, a value from a first device. The value represents a composite waveform corresponding to a real component and an imaginary component of a frequency domain data. The apparatus may also include means for recovering, at the second device, the frequency domain data via the index of the value.

According to certain embodiments, a non-transitory computer-readable medium encoding instructions that, when executed in hardware, perform a process. The process may include receiving, at a second device, a value from a first device. The value represents a composite waveform corresponding to a real component and an imaginary component of a frequency domain data. The process may also include recovering, at the second device, the frequency domain data via the index of the value.

According to certain other embodiments, a computer program product may encode instructions for performing a process. The process may include receiving, at a second device, a value from a first device. The value represents a composite waveform corresponding to a real component and an imaginary component of a frequency domain data. The process may also include recovering, at the second device, the frequency domain data via the index of the value.

### BRIEF DESCRIPTION OF THE DRAWINGS

For proper understanding of the invention, reference should be made to the accompanying drawings, wherein:

FIG. 1 illustrates a flow diagram according to certain embodiments.

FIG. 2 illustrates a downlink subframe according to certain embodiments.

FIG. 3 illustrates a composite constellation according to certain embodiments.

FIG. 4 illustrates a composite constellation according to certain embodiments.

FIG. 5 illustrates a flow diagram according to certain embodiments.

FIG. 6 illustrates a flow diagram according to certain embodiments.

FIG. 7 illustrates a system diagram according to certain embodiments.

### DETAILED DESCRIPTION

Certain embodiments provide for a fronthaul interface communication approach between two network entities, for example, a BBU and an RRU, which includes frequency domain data. Frequency domain data over a fronthaul interface may allow for lower bandwidth usage and more delay/jitter tolerance as compared to traditional time domain data approaches, such as CPRI and OBSAI. In part, this may be because smaller traffic takes a shorter time to be transported, which leads to smaller delays. Smaller traffic can also be less likely to block, or to be blocked by, other traffic sharing the same physical link, which leads to smaller jitters.

Frequency domain traffic bandwidth may be further reduced using compression techniques, in some embodiments. Compression can act to further reduce transport latency and signal jitters. In addition, in some embodiments compression can allow for more fronthaul traffic to be aggregated together to be transported over a long haul fiber, which may be used to serve more remote radio units. Certain embodiments may apply to any case where compression of frequency domain data transmitted between network entities can provide a benefit.

Certain embodiments may provide for an improved technique of compressing downlink frequency domain antenna data. This embodiment may not only demand less bandwidth than other techniques, but the embodiment can also maintain precision of the signal. Certain embodiments utilize compression of the real and imaginary (I and Q) components together that may be represented by a value. In certain embodiments, a look up table may be created which may have a list of waveforms. For example, a look up table may have an exhaustive list of all possible waveforms. Certain embodiments may then send or cause the transmission of only the value, or an index of the look up table, over the fronthaul interface with a small amount of header information.

In other embodiments, the downlink subframe may be divided into several sub-regions. The sub-regions may be divided according to a common transmission characteristic. In some embodiments, each sub-region may have its own look up table, based on the common transmission characteristics of the sub-region. These common characteristics may be included in the header portion of the sent packet, along with a value, for example, an index of a look up table.

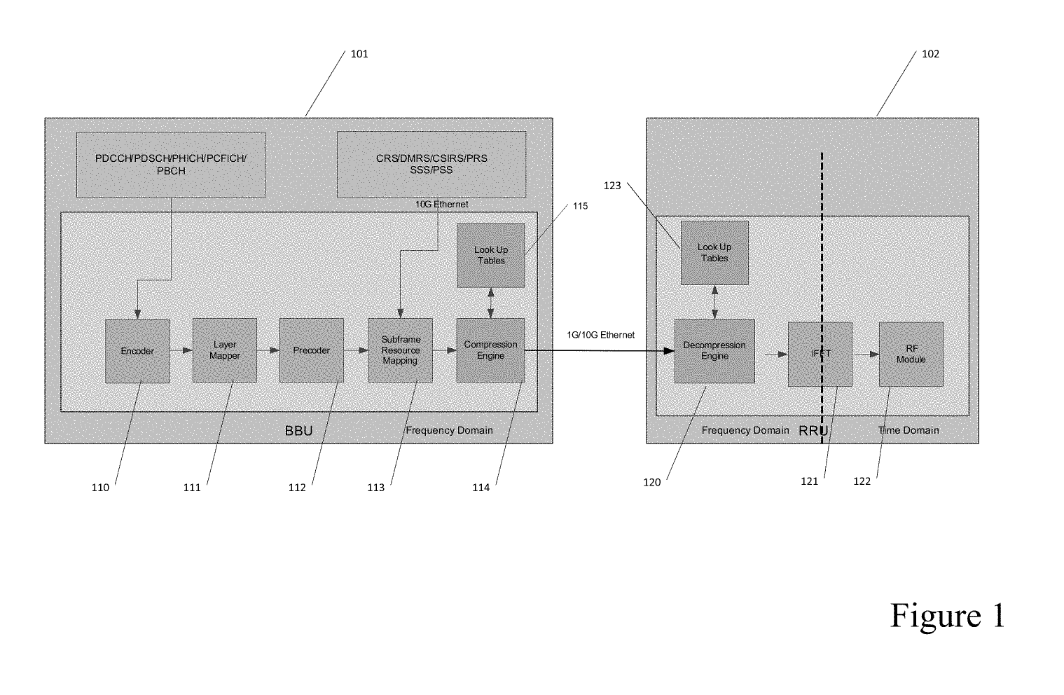

FIG. 1 illustrates a flow diagram according to certain embodiments. Specifically, FIG. 1 illustrates a fronthaul communication approach, which in one example may be Ethernet based, between a first device, for example a BBU 101, and a second device, for example a RRU 102. The BBU may include an encoder 110. Encoder 110 may process at least one of a Physical Downlink Shared Channel (PDSCH), a Physical Downlink Control Channel (PDCCH), a Physical Hybrid ARQ Indicator Channel (PHICH), a Physical Control Format Indicator Channel (PCFICH), or a Physical Broadcast Channel (PBCH). When processing with at least one of these channels, encoder 110 can receive data and convert that data into a codeword, which can eventually be scrambled and converted into a modulation symbol.

The codeword may then be scrambled, which reveals the bit sequence of the data represented by the codeword. This data can be converted into a corresponding modulation symbol. For example, the scrambled bits may be modulated using a modulation scheme supported in the downlink, such as QPSK, QAM16, QAM64, or QAM256, which results in a complex-valued modulation symbol. In other words, the codeword can be scrambled into a bit sequence, which can eventually become a complex-valued modulation symbol.

Further, a layer mapper 111 may be used to map the complex-valued modulation symbol to one of several transmission layers. The codewords, for example, may be mapped to a single layer, or each of the codewords may be mapped to its own layer. In certain embodiments, the number of layers may be less than or equal to the number of antenna ports used to transmit the modulation symbols.

A precoder 112 may then be used to precode the modulation symbols on each layer for transmission on the antenna ports. In other words, precoding may be used to assign the modulation symbols to a specific antenna port for transmission. The precoding may be determined by a downlink scheduler, which schedules downlink transmission to user equipments for a subframe.

After precoding, subframe resource mapping in step 113 occurs. This may allow the modulation symbols on each antenna port to be mapped to resource elements. In some embodiments, the modulation symbols may be mapped to subframes and/or sub-regions of the subframe. The resource elements may be used to transmit the modulation symbols to the RRU.

The BBU may receive at least one of cell-specific reference signal (CRS), demodulation reference signal (DMRS), positioning reference signal (PRS), cell specific reference signal (CSIRS), primary sync signal (PSS), or secondary sync signal (SSS). The resource elements used by CRS, DMRS, PRS, CSI-RS, PSS, SSS can be predetermined. After precoding and physical resource mapping, the frequency domain data on each subcarrier for each antenna has been determined. The BBU may then generate a complex-valued OFDM signal for each antenna port.

In certain embodiments, the frequency domain data on each subcarrier for each antenna may have been determined during or after subframe resource mapping 113. The frequency domain data may not be limited to simple generic modulation types, such as QPSK, QAM16, QAM64, and QAM 256. Rather, the frequency domain data may be represented by more complex waveforms that require more resolution.

In some embodiments, various scenarios for the downlink of the frequency data may be reflected in different transmission modes (TMs). For example, the first transmission mode (TM1) may correspond to a single-antenna port transmission. The seventh transmission mode (TM7), on the other hand, may correspond to a beamforming transmission.

In transmission modes TM2, TM3, TM4, and TM9, there can be a finite number of code book entries, resulting in a finite number of waveforms that can come about after precoding. In certain embodiments, each TM may have one or more precoders. In transmission mode TM7 and TM8, which utilize beamforming and dual-layer beamforming, respectively, the precoder may be a common complex weight across the entire user equipment specific region. In certain embodiments, the complex weight may be transmitted from BBU 101 to RRU 102 as header information. By doing so, in certain embodiments, the waveforms may still be finite, and the complex weight can be applied after decompression.

After the subframe resource mapping 113, the frequency domain data can be determined at data subcarriers. The frequency domain data may be presented as a complex number, comprising a real I component and an imaginary Q component. The value of I, Q pair represents a unique waveform at that subcarrier. For example, in LTE, there are a finite number of possible I, Q pairs for a downlink signal. Therefore, in certain embodiments, an exhaustively list of all possible I, Q pairs can be presented. In some embodiments, a look up table 115 for the possible I, Q pairs may be formulated. Since each I, Q pair represents a unique waveform, look up table 115 may also be a look up table of all possible waveforms.

A compress engine 114 may then receive the real I and imaginary Q components of the frequency domain data, search the look up table and identify the waveform that corresponds to the I, Q pair. A value representing the composite waveform, for example, the index to the waveform in the look up table, can then be returned to the compression engine 114 to be transmitted over the fronthaul interface.

As shown in FIG. 1, a compression engine 114 can be used to compress or identify the complex waveforms at BBU 101 before the transmission of the value, for example, an index of the look up table, and header information, which may contain the common characteristics, to RRU 102. In certain embodiments, the real and imaginary (I and Q) components of the frequency domain data can be represented together as a composite waveform. Rather than compressing I and Q components separately, I and Q components can be compressed together to form a composite waveform. A partial or exhaustive list of possible composite waveforms can then be listed as a composite constellation to form a look up table 115.

Because a finite number of composite waveforms can exist in the downlink, it may be possible to create an exhaustive list of all possible waveforms in look up table 115. Instead of sending the composite waveform, a value, such as an index of the look up table, representing the composite waveform may be sent or transmitted to conserve bandwidth. In other words, the value, for example, the index of the waveform inside the look up table can be used instead of the compressed frequency data that is sent over the fronthaul interface. In other words, the index, which represents the compressed frequency domain data may be transmitted instead of the frequency domain data itself. In addition, certain embodiments may include a plurality look up tables, each table being used for a sub-region having a common characteristic.

In some embodiments of FIG. 1, the table index can be sent from the BBU 101 to RRU 102 via a front haul interface. For example, a 1 gigabyte or a 10 gigabyte Ethernet connection may be used. A decompression engine 120 receives the a value representing the composite waveform, for example a table index, and uses the index, along with look up table 123 in the RRU, to decompress the received waveform and recover the frequency domain data. In certain embodiments, a look up table may be created or re-created once a sub-region with a common characteristic is designated For example, the RRU may be informed of the characteristics of a sub-region, at which point it may re-create the appropriate look up table based on the characteristic of the sub-region. In 121, an inverse fast Fourier transformation (IFFT) may be performed on the decompressed frequency domain data. Once the IFFT is complete, the frequency domain data can be converted into time domain data and sent to a Radio Frequency (RF) module 122. RF module 122 may then use the information to propagate the data to associated UEs. In certain embodiments, the size of the look up table may determine the compression ratio. For example, if bandwidth is limited in the fronthaul transport, one may increase the compression ratio further by using a smaller look up table with tightened search criteria, at the expense of more look up tables. In this embodiment, the compression ratio may be adaptively changed to match the available bandwidth, which makes the embodiment advantageous in a C-RAN where a front interface, for example Ethernet, may be the dominant media.

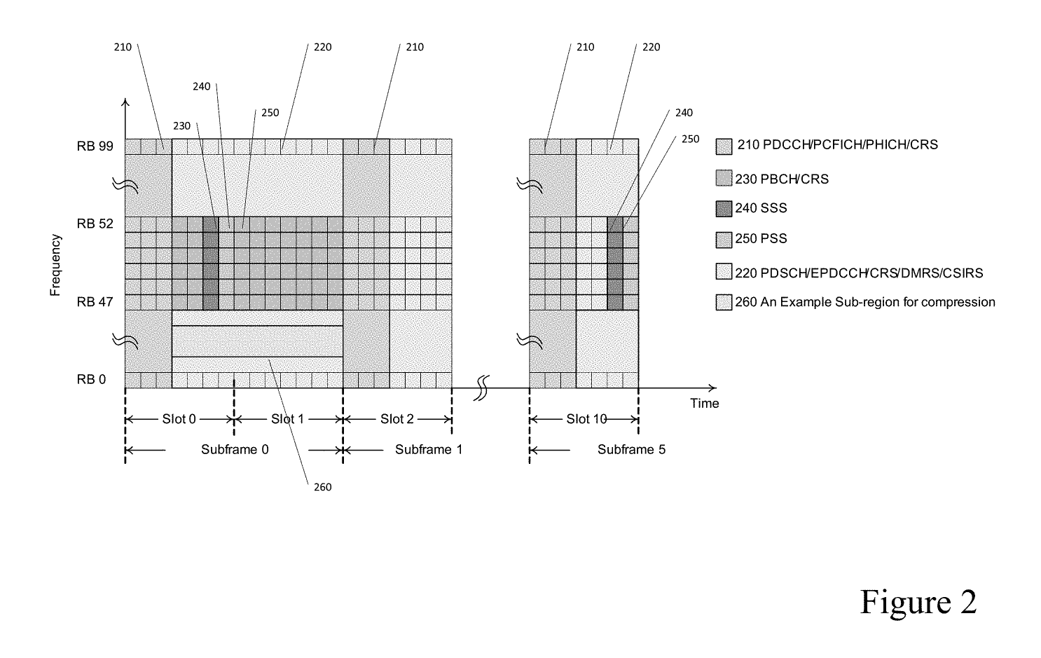

FIG. 2 illustrates a downlink subframe according to certain embodiments. Specifically, FIG. 2 illustrates a technique by which to divide a downlink subframe into two or more sub-regions. Certain embodiments may be divided along both the frequency and the time domain to form sub-regions. The sub-regions may be determined based on a set of common characteristics for the region. The characteristics, for example, may be at least one of a transmission mode, modulation type, number of layers, or rank. The smallest sub-region can be a single resource block or less. For example, a sub-region may be one or more subcarriers contained within a given sub-region.

Certain embodiments provide for an adaptive method to save bandwidth by subdividing the downlink subframe into two or more sub-regions. The selection of the sub-region can be based on a set of common characteristics or criteria of the sub-region. Common characteristics may then be used as search criteria for locating different look up tables. In other words, each sub-region may use its own look up table that can be found using the common characteristic. In some embodiments, the more common characteristics or criteria used to define a sub-region, the fewer the number of possible waveforms are in the look up table of the sub-region. As a result, the size look up table may be dynamically changed according to available bandwidth. Using the above embodiments, therefore, one can dynamically adjust the common characteristic of a sub-region set such that the size of the resultant sub-region can adapt to the available bandwidth.

In addition, in certain embodiments, each sub-region may use its own look up table. For example, sub-regions 210 may represent sub-regions in which downlink control channels are being transmitted. In certain embodiments, in sub-regions 210, the transmission mode may always be TM2 (Tx diversity). Different look up tables can be formulated according to common transmission characteristics. In certain embodiments, a single composite constellation look up table having a given size can be used to represent waveforms in this sub-region having a Tx diversity precoder. In sub-regions 210, for example, the waveforms may include PDCHH, PCFICH, PHICH, or CRS.

Sub-regions 220 may define the entire bandwidth of the dedicated data region, where PDSCH and EPDCH are transmitted. Sub-regions 220 may be further divided into one or more sub-sub-regions that have a common transmission characteristic. For example, PBCH and CRS 230 may occupy at least a portion of a sub-region or a sub-sub-region. In addition, SSS 240 and PSS 250 may also occupy at least a portion of a sub-region or a sub-sub-region. Sub-region 260 can be a subset of region 220, and may represent an exemplary sub-region for compression. The number of possible waveforms in region 220 may be larger than 260, and can require a larger look up table.

In some embodiments, a small amount of header information that describes the common characteristics of the sub-region may be added for each sub-region so as to indicate to the decompression entity which look up table to use. The header information may also include complex weights on a per antenna basis for the entire sub-region, in an embodiment involving beamforming in TM7 and TM8.

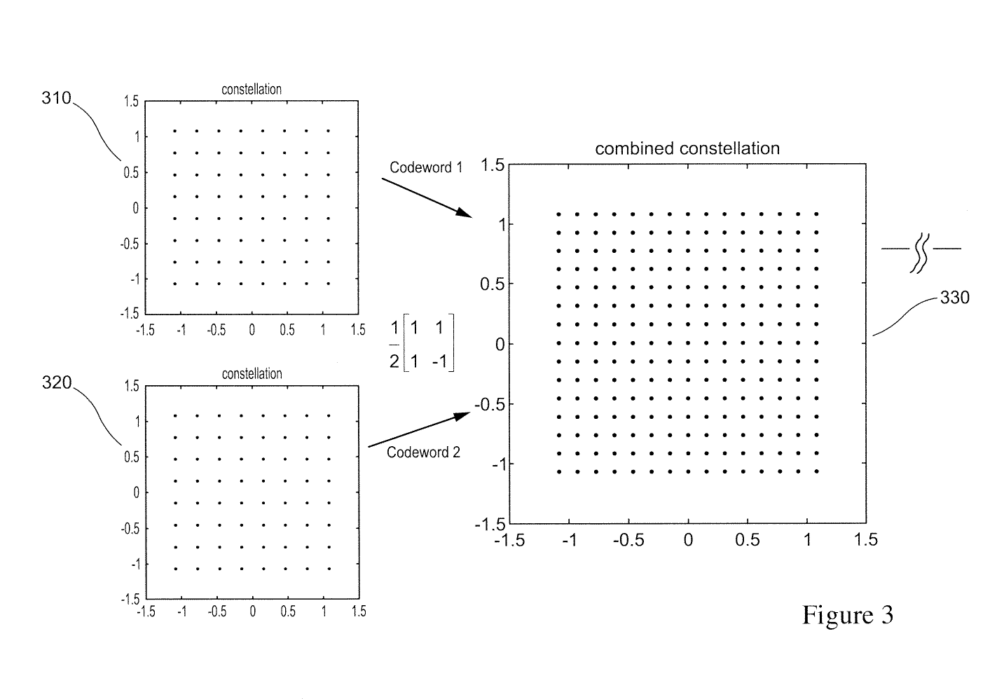

FIG. 3 illustrates a composite constellation according to certain embodiments. FIG. 3 assumes that codeword 1 and codeword 2 are both QAM 64, with a precoding matrix equal to 1. As shown in FIG. 3, constellation 310, represented by codeword 1, and constellation 320, represented by codeword 2, are precoded via a two by two precoding matrix. After precoding, the two QAM 64 constellations 310, 320 will produce a combined constellation 330 having a maximum of 225 distinctive waveforms in the frequency domain. The look up table in both the BBU and the RRU in FIG. 1, therefore, may contain a comprehensive list of 225 waveforms. As described above, the transmitted index will then be used to decompress the appropriate waveform from the comprehensive list.

According to the embodiments of FIG. 3, the look up table can be used to represent 225 composite constellations. Only 8 bits may be needed to represent the waveform in the above embodiments. In addition, there will still be 31 unused indexes available for use by other waveforms, such as, CRS and DMRS. The 31 unused indexes may be calculated by subtracting 225 from 2⁸. In addition, using the look up table, and the transmitted index of the look up table, allows for an improved precision, with a limited error vector magnitude (EVM).

Contrary to the above embodiments, which utilize a compression involving a value, for example an index of a look up table, in a comparative example that does not use a compression technique, 32 bits may have been needed to transmit the waveform—16 bits for I and 16 bits for Q. Using linear truncation, for example, to transmit the waveform would have required 16 bits. In linear truncation, one would normalize the 16 bit I and Q components to the full scale based on the largest I and Q data. The I and Q components can then truncate the 8 least significant bits, leading each resource element to have 8 bits for I and 8 bits for Q. Linear truncating, therefore, may result in a total of 16 bits, and an EVM loss of about 1%.

Another possible comparative example may be to use a U-law compression, instead of the above embodiments involving a value, for example an index of the look up table. In a U-law compression, a mantissa or exponent may be used to represent the data. Assuming that a 4 bit mantissa, a 3 bit exponent, and a 1 sign bit are used, each resource element can require 8 bits for I and 8 bits for Q, for a total of 16 bits. The EVM loss associated with U-law compression is about 1.2%.

As illustrated in FIG. 3, on the other hand, using a look up table to represent the 225 composite constellations may help to prevent loss of precision, while also lowering, or even eliminating, the EVM loss. By using the combined constellation, only 8 bits will be needed to represent the waveform, as opposed to at least 16 bits needed by other compression procedures, or 32 bits without the use of a compression procedure.

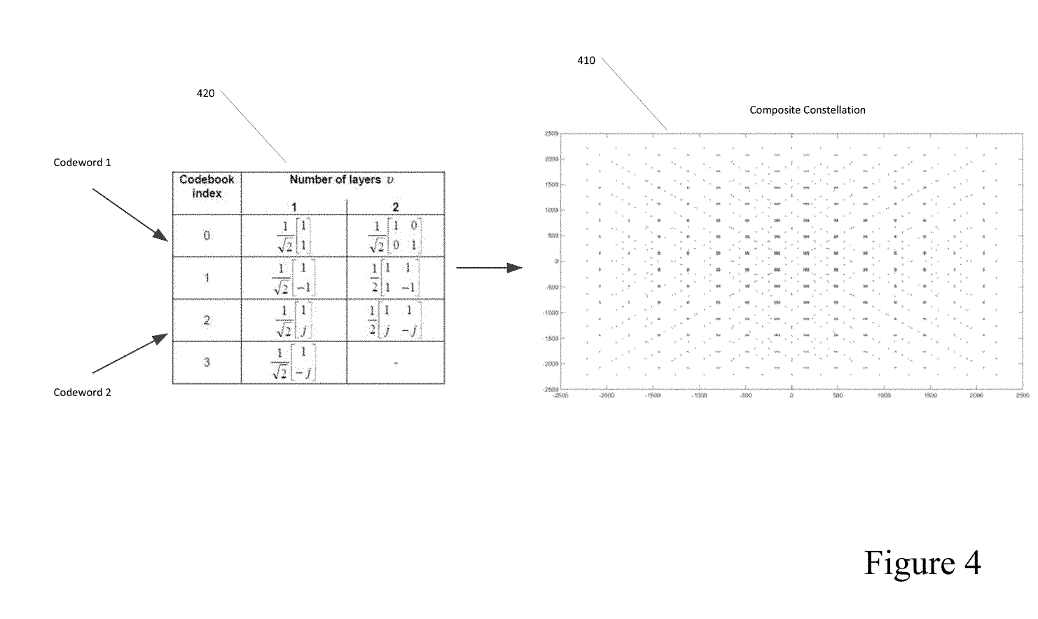

FIG. 4 illustrates a composite constellation according to certain embodiments. Specifically, FIG. 4 illustrates a composite constellation 410 in which all possible precoders for the same transmission mode, for example, TM4, with all possible modulation type combinations, for example, QPSK, QA16, and QAM64. A table of all possible precoders 420 is illustrated in FIG. 4. In order to cover the entire TM4 for a two antenna case, regardless of rank or modulation type, a new composite constellation 410 may have a maximum of 1709 of distinctive waveforms that can be reached.

As discussed above, in certain embodiments the composite constellation number may be 1709. If reference signals and synchronization signals that exist in the PDSCH region are added, the total number of composite constellations may still be less than 2048. Using the above embodiment, the entire TM4 two antenna cases for the PDSCH sub-region may be covered using only 11 bits (2¹¹=2048). Compared to a linear compression, a U-law compression, or even no compression, the above embodiment is more bandwidth efficient and lossless.

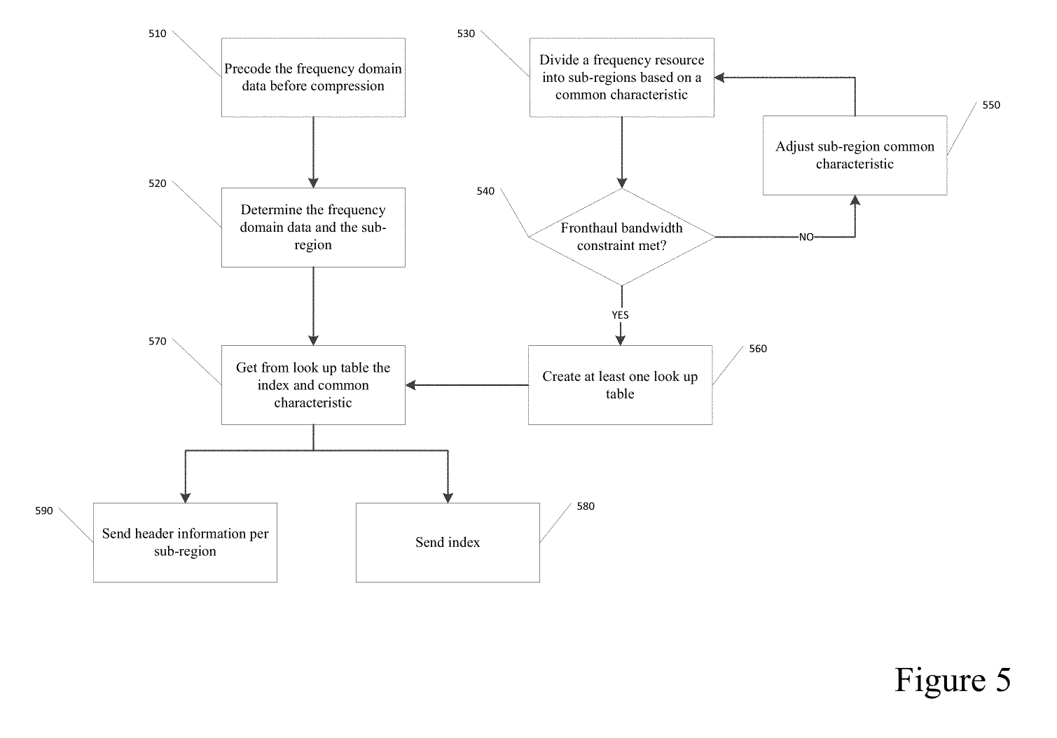

FIG. 5 illustrates a flow diagram according to certain embodiments. In step 510, the frequency domain data may be precoded before compression occurs in the baseband unit. In step 520, the frequency domain data and the sub-regions may be determined. In step 530, the frequency resource may be divided into sub-regions based on common characteristics or criteria. If the fronthaul bandwidth constraints are met, in step 540, then at least one look up table may be created in step 560. However, if the fronthaul bandwidth constraints are not met, meaning that sufficient fronthaul bandwidth to transmit the frequency resource does not exist, then the sub-region common characteristic can be adjusted, in step 550. This adjustment may involve decreasing the size of the resultant sub-region.

In certain embodiments, a look up table can be created for each sub-region using the common characteristics of the sub-region, as shown in step 560. Upon receiving the frequency domain data, which comprises a complex number including an I, Q pair, the I, Q pair may be used to search the look up table of the sub-region to which the frequency domain data belongs in order to produce an index representing composite waveform, as shown in step 570. The index may then be sent to the radio unit in step 580. In some embodiments, only one index per frequency domain data is sent. In other embodiments, a value may be used to represent the composite waveform that comprises the I and Q pair, without a look up table or index.

The common characteristics of the sub-region may also be sent to the radio unit. The common characteristics can be sent as header information, with some embodiments only sending header information once per sub-region. The radio unit may then use the header information it receives to reconstruct the look up table and store the look up table in a memory of the radio unit. When the radio unit receives the index from the base band, the radio unit may use the index that represents the composite waveform to check the corresponding look up table to retrieve the frequency domain data according to the index, and the composite waveform the index represents.

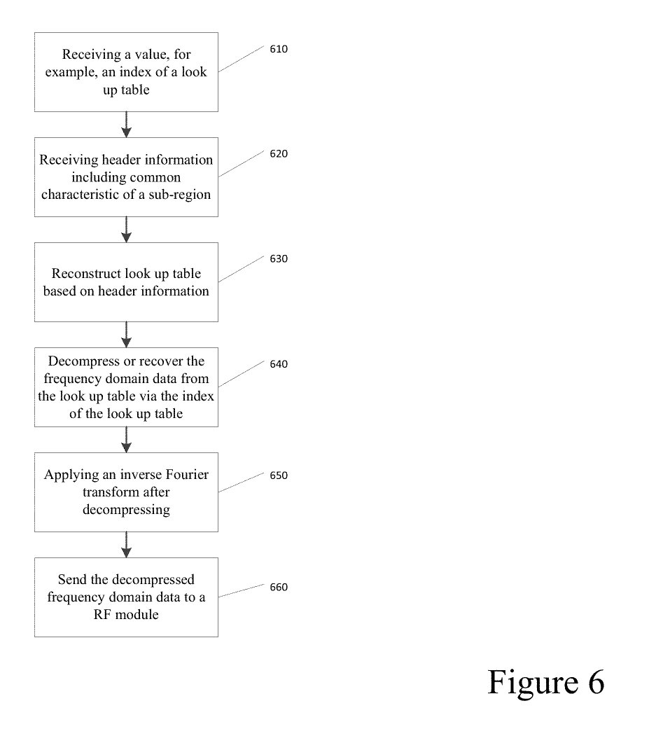

FIG. 6 illustrates a flow diagram according to certain embodiments. In step 610, a remote radio unit may receive a value, for example, an index of a look up table, including information about compressed frequency domain data. The remote radio unit may also receive header information including the common characteristics or criteria of the sub-regions, as shown in step 620. In step 630, the look up table may be reconstructed and stored in the memory of the radio unit based on the received header information. Using the index the remote radio unit may decompress or recover the frequency domain data from the look up table, as shown in step 640. In other embodiments, a value representing the composite waveform may be used to recover the frequency domain data. In step 650, an IFFT can be applied to the decompressed or recovered data. An interface boundary may be defined between steps 640 and 650. Once the frequency domain data is converted to time domain data after 650, the data may be sent to an RF module in step 660.

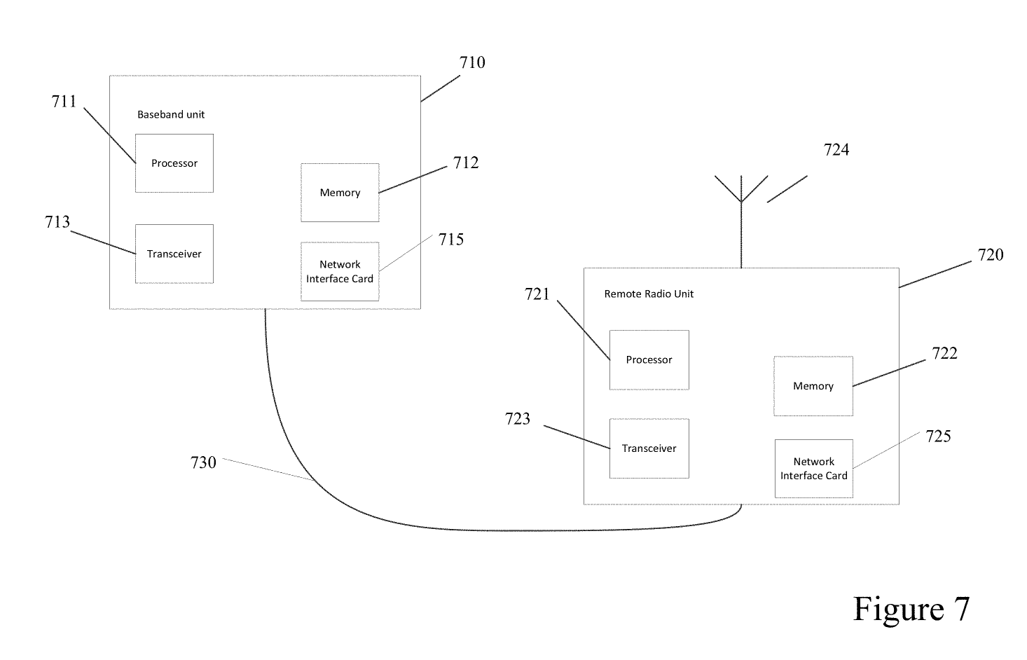

FIG. 7 illustrates a system according to certain embodiments. It should be understood that each block of the flowchart of FIGS. 1, 5 and 6, or any combination thereof, may be implemented by various means or their combinations, such as hardware, software, firmware, one or more processors and/or circuitry. In one embodiment, a system may include several network devices, such as, for example, a second device may be a remote radio unit 720 and a first device may be a baseband unit 710. The system may include more than one baseband unit 710 and more than one remote radio unit 720, although only one remote radio 720 and one baseband unit 710 are shown for the purposes of illustration.

Each of these devices may include at least one processor or control unit or module, respectively indicated as 711 and 721. At least one memory may be provided in each device, and indicated as 712 and 722, respectively. The memory may include computer program instructions or computer code contained therein. One or more transceiver 713 and 723 may be provided. Remote radio unit 724 may include an antenna 724. Antenna 724 may illustrate any form of communication hardware, without being limited to merely an antenna. Although only one antenna is shown, many antennas and multiple antenna elements may be provided in the remote radio unit. Although in some embodiments the baseband unit may have an antenna as well, which will allow for wireless communication, the baseband unit may be configured for wired communication through cable 730. The remote radio unit 720 and baseband unit 710 may both be configured to communicate through a wire communication, using cable 730, or any other form of communication.

In addition to some embodiments having the baseband unit 710 connected to the remote radio unit 720 via cable 730, both the baseband unit 710 and remote radio unit 720 may have a network interface card, as indicated by 715 and 725, respectively. Network interface cards 715 and 725 may take any form, and help facilitate communications between the baseband unit 710 and the remote radio unit 720 through cable 730.

Transceivers 713 and 723 may each, independently, be a transmitter, a receiver, or both a transmitter and a receiver, or a unit or device that may be configured both for transmission and reception.

In some embodiment, an apparatus, such as a baseband unit or a remote radio unit, may include means for carrying out embodiments described above in relation to FIGS. 1, 5, and 6. In certain embodiments, at least one memory including computer program code can be configured to, with the at least one processor, cause the apparatus at least to perform any of the processes described herein.

According to certain embodiments, an apparatus 710 may include at least one memory 712 including computer program code, and at least one processor 711. The at least one memory 712 and the computer program code may be configured, with the at least one processor 711, to cause the apparatus 710 at least to identify a composite waveform corresponding to a real component and an imaginary component of a frequency domain data at a first device. The at least one memory 712 and the computer program code may also be configured, with the at least one processor 711, to cause the apparatus at least to cause a transmission of a value that represents the composite waveform to a second device from the first device.

An apparatus 710, in certain embodiments, may include means for identifying a composite waveform corresponding to a real component and an imaginary component of a frequency domain data at a first device. The apparatus 710 may also include means for causing a transmission of a value that represents the composite waveform to a second device from the first device.

According to certain embodiments, an apparatus 720 may include at least one memory 722 including computer program code, and at least one processor 721. The at least one memory 722 and the computer program code may be configured, with the at least one processor 721, to cause the apparatus 720 at least to receive, at a second device, a value from a first device. The value represents a composite waveform corresponding to a real component and an imaginary component of a frequency domain data. The at least one memory 722 and the computer program code may also be configured, with the at least one processor 721, to cause the apparatus at least to recover, at the second device, the frequency domain data via the value.

An apparatus 720, in certain embodiments, may include means for receiving, at a second device, a value from a first device. The value represents a composite waveform corresponding to a real component and an imaginary component of a frequency domain data. The apparatus 720 may also include means for recovering, at the second device, the frequency domain data via the value.

Processors 711 and 721 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 712 and 722 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as baseband unit 710 or remote radio unit 720, to perform any of the processes described above (see, for example, FIGS. 1, 5, and 6). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

Furthermore, although FIG. 7 illustrates a system including a baseband unit 710 and a remote radio unit 720, certain embodiments may be applicable to other configurations, and configurations involving additional elements, as illustrated and discussed herein. For example, multiple baseband units and multiple remote radio units may be present.

Certain embodiments provide for the compression of downlink frequency domain data in a lossless manner that helps to improve the bandwidth efficiency of the communication system. By utilizing a value to represent the composite waveform that comprises an I and Q pair, for example, an index of the look up table, the above embodiment can easily be implemented both at the compression and decompression sides. The above embodiments may not only optimize the speed of the compression and decompression, but can also require less bits than other compression or decompression methods.

In addition, some embodiments provide for a clear interface boundary, before IFFT is conducted. Compression, therefore, can occur after precoding, and decompression may occur before the IFFT.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. The above embodiments may be applied in at least C-RAN, virtualized network, Internet of Things, and 5^{th} generation mobile networks or wireless systems.

Partial Glossary

BBU Baseband Unit

CPRI Common Public Radio Interface

C-RAN Cloud Radio Access Network

OBSAI Open Base Station Architecture Initiative

RRU Remote Radio Unit

RAN Radio Access Network

We claim:

1. An apparatus comprising:
at least one memory comprising computer program code;
at least one processor;
wherein the at least one memory and the computer program code are configured, with the at least one processor, to cause the apparatus at least to:
identify a composite waveform corresponding to a real component and an imaginary component of a frequency domain data at a first device; and
causing a transmission of a value that represents the composite waveform to a second device from the first device.

2. The apparatus according to claim 1, wherein the value comprises an index of a look up table.

3. The apparatus according to claim 1, wherein the at least one memory and the computer program code are configured, with the at least one processor, to cause the apparatus at least to:
precode the frequency domain data, wherein the precoding occurs before the identification of the composite waveform.

4. The apparatus according to claim 1, wherein the first device is a baseband unit, and wherein the second device is a radio unit.

5. The apparatus according to claim 2, wherein the at least one memory and the computer program code are configured, with the at least one processor, to cause the apparatus at least to:
divide a frequency resource into at least one sub-region based on a common characteristic; and
adjust a size of the look up table based on the common characteristic of the at least one sub-region.

6. The apparatus according to claim 5, wherein the common characteristic comprises at least one of a transmission mode, a modulation type, or a number of layers.

7. The apparatus according to claim 5, wherein the at least one sub-region has a corresponding look up table based on the common characteristic of the sub-region.

8. The apparatus according to claim 5, wherein the sub-region comprises header information about the common characteristic, where the header information indicates the appropriate look up table to use.

9. The apparatus according to claim 8, wherein the at least one memory and the computer program code are configured, with the at least one processor, to cause the apparatus at least to:
send the header information from the first device to the second device.

10. The apparatus according to claim 8, wherein the header information comprises a complex weight associated with a transmission mode.

11. An apparatus comprising:
at least one memory comprising computer program code;
at least one processor;
wherein the at least one memory and the computer program code are configured, with the at least one processor, to cause the apparatus at least to:
receive, at a second device, a value from a first device, wherein the value represents a composite waveform corresponding to a real component and an imaginary component of a frequency domain data; and
recover, at the second device, the frequency domain data via the value.

12. The apparatus according to claim 11, wherein the value comprises an index of a look up table.

13. The apparatus according to claim 11, wherein the at least one memory and the computer program code are configured, with the at least one processor, to cause the apparatus at least to:
transmit the frequency domain data to a radio frequency module from the second device.

14. The apparatus according to claim 11, wherein the at least one memory and the computer program code are configured, with the at least one processor, to cause the apparatus at least to:
receive header information at the second device from the first device, wherein the header information comprises a common characteristic of at least one sub-region of a frequency resource.

15. The apparatus according to claim 14, wherein the header information is used to reconstruct a look up table at the second device.

16. The apparatus according to claim 12, storing the look up table in the second device before receiving the index of the look up table.

17. The apparatus according to claim 11, wherein the first device is a baseband unit, and wherein the second device is a radio unit.

18. The apparatus according to claim 12, wherein a size of the look up table is adjusted based on at least one sub-region of a frequency resource, and wherein the frequency resource is divided into at least one sub-region based on a common characteristic.

19. The apparatus according to claim 18, wherein the common characteristic comprises at least one of a transmission mode, a modulation type, a number of layers, or a rank.

20. The apparatus according to claim 19, wherein the at least one sub-region has a corresponding look up table based on the common characteristics of the at least one sub-region.

21. A method comprising:
identifying a composite waveform corresponding to a real component and an imaginary component of a frequency domain data at a first device; and
causing a transmission of a value that represents the composite waveform to a second device from the first device.
